(19) United States
(12) Patent Application Publication
(10) Pub. No.: US 2002/0169000 A1
(43) Pub. Date: Nov. 14, 2002

(54) Modem function and usage of a personal digital assistant in wireless mode

(76) Inventor: John Fredrick King, Downers Grove, IL (US)

Correspondence Address: C. John Brannon, 2700 Market Tower, 10 West Market Street, Indianapolis, IN, 46204, US

(21) Appl. No.: 10/140,514

(22) Filed: May 7, 2002

Related U.S. Application Data
(60) Provisional application No. 60/289,259, filed on May 7, 2001.

(51) Int. Cl. H04M 1/00

(52) U.S. Cl. 455/556; 455/557

(57) ABSTRACT

A method for using a personal digital assistant having a wireless communications transceiver to connect a personal computer to a computer network, such as the Internet. The method includes programming or instructing the transceiver to emulate the connectivity function of a modem, establishing a communications link between the personal digital assistant and the personal computer, and wirelessly connecting the personal computer the Internet through the personal digital assistant.

This application claims priority to U.S. Provisional Patent Application Serial No. 60/289,259 filed May 7, 2001.

### BACKGROUND OF THE INVENTION

The personal computer has become increasingly ubiquitous and useful. One important and popular use of the personal computer is as an access portal to computer networks, the most well know being the Internet. However, not all personal computers are equipped with internal modems for connecting the computer through pre-existing physical communications lines (such as telephone or dedicated fiber optic lines) to Internet service providers. Further, in the case of portable or laptop computers, the computer may not always be present in a location sporting preexisting communication lines to which its internal modem (if present) may be connected.

One way of connecting a personal computer to the Internet without connecting through physical communications lines is through a wireless air card device. A wireless air card is a dedicated wireless device that consists of a transceiver that connects via a wireless network such as cellular telephone, with a specific format, such as a CDPD format. The device may be connected to a computer having a compatible connection, such as a PCMCIA slot, and costs about $500. Such an air card is typically limited to a relatively slow maximum information transfer rate of about 9600 baud. A wireless air card further requires the user to have an account with a wireless service provider's network or like provider, and its use generates billed airtime at some rate determined by the specifics of the plan provided by this service provider of choice.

Another method is through a wireless network interface using 802.11a or b protocol, but this is not designed for coverage of a large regional or national area in that it is specifically limited to low power and was established to provide for needs in a Local Area Network setting.

The only other way to achieve wireless connectivity with a personal computer is through a cellular telephone connected to the computer, typically through a serial port and used as a dial-up modem. This method suffers from the disadvantages of being relatively expensive, insofar as use of the cellular telephone is still billed according to the specific parameters of the user's cellular telephone plan which is typically billed by the minute and is generally more expensive than regular telephone service over landlines. Further, the data transfer rate is typically at most about 9600 baud. Also, use of a cellular telephone as a computer modem necessarily precludes its use as a telephone while still costing normal voice rate airtime and quickly discharging its battery (generally with no way to recharge or use external power since for a typical cellular telephone configuration, the data connection and the external power connection are the same.)

There is therefore a need for an alternate, relatively inexpensive method of wirelessly connecting a personal computer to the Internet with an accelerated data transfer rate. The present invention addresses this need.

### SUMMARY OF THE INVENTION

The present invention relates to a method and apparatus for a communications system including a personal or stand-alone computer, a computer network such as a LAN, WAN, or the Internet, and a personal digital assistant connected in electric communication to the computer and in wireless communication to the computer network. The personal digital assistant includes a wireless transceiver that may be programmed to emulate a modem. The personal computer is enabled to access the network through the modem function of the personal digital assistant.

As used herein, modem function relates to the utilization of an external device in cooperation with a PC or portable computer to result in a data connection to a computer network such as the Internet, a hard-wired network or wireless network. Although the external device does not necessarily perform the function of information modulation/demodulation as the information is transferred, the device does function similarly to a modem insofar as it connects the PC or Portable Computer to a computer network via a standard serial communications port or a USB port, thus providing the same connectivity to the computer network as would a modem.

By using the PDA as an alternative transport, the PC will recognize the PDA device as a network interface. This network interface can be accessed as any other network interface on the PC or Portable Computer, and therefore provides connectivity to whichever wireless network the PDA device is subscribed. This wireless connectivity allows for a connection to equipment located on the wireless network, completing the transport function of the present invention.

One object of the present invention is to provide an improved communications system. Related objects and advantages of the present invention will be apparent from the following description.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

History of the Personal Digital Assistant

Small computer organizers first became available in the 1980s. The first personal digital assistants (PDAs) were large, bulky, expensive and complicated. The modem hand-held PDAs are capable of performing the functions of storing data such as addresses and phone numbers, taking notes and maintaining an appointment calendar and first became available in the 1990s. In 1996, the original PALM PILOT™ (available from Palm, Inc., 5470 Great American Parkway, Santa Clara, Calif. 95054) was introduced. The PALM PILOT™ was small and light, energy efficient (powered by standard AAA batteries), and user-friendly. The PALM PILOT™ was developed with a simplified user interface and sufficient memory for storing thousands of pieces of data, such as contacts, appointments and notes. Consequently, the PALM PILOT™ was quite successful, and inspired other computer manufacturers (such as IBM, Sony, Hewlett-Packard, and others) to develop their own lines of similar PDAs. PDAs have evolved beyond their original design as electronic appointment books into machines for performing relatively complex mathematics and calculations, running business and entertainment programs, playing music and connecting, browsing, and downloading information from the Internet.

Substantially all PDAs share the same basic features: a microprocessor, an internal operating system, solid-state memory, a display (usually liquid crystal or LCD type), a user interface (preferably a keyboard and/or a touch screen), an input/output (I/O) port, and a portable power source (such as a battery pack). Additionally, PDAs usually come equipped with software for the PC to which the PDA will be interfaced, since PDAs are generally considered as complimentary devices for the PC and not as functional PCs themselves.

PDAs are powered by microprocessors as are traditional PCs, albeit usually much less powerful microprocessors. The microprocessor coordinates all of the PDA's functions according to its preprogrammed instructions. Although the PDA microprocessors are generally slower than those of PCs (typically about 50-100 MHz as compared with 1,000+ MHz), they are adequate for the functions required of the PDAs. Moreover, the less powerful microprocessors are less expensive, smaller and lighter, all of which are desirable factors for PDAs. Like the PC, the PDA uses an operating system containing pre-programmed instructions for the microprocessor. The operating systems used by PDAs are not as complex as those used by PCs. Typically, the PDA operating system is more simplified and therefore requires less memory. PDAs typically use one of two operating systems, PALM OS™ (available from Palm, Inc.) or POCKETPC™ (formerly called Windows CE, Microsoft, and available from Microsoft, One Microsoft Way, Redmond, Wash. 98062-6399). PALM OS™ takes up less memory and runs faster, and is generally simpler to use. POCKETPC™ easily supports color displays, graphics, WINDOWS™ software packages, and other devices (such as built-in MP3 players or MPEG movie players). Other operating systems are currently in development.

Most, if not all, PDAs have no hard drive. PDAs store their core programs (such as address book, calendar, memo pad and operating system) in a read-only memory or ROM chip. The programs do not require power for storage and thus remain intact when the PDA is turned off and when the power source is removed. Data and programs added later by the user are stored in the PDA's random access memory or RAM, and are maintained by a constant low current drawn from the power source. This memory configuration has the advantage of immediate access to programs and data after activating the PDA. In other words, there is virtually no boot-up time during which applications are loaded involved when the PDA is turned on. File changes are often stored automatically without the requirement of a user issued ‘save’ command. PDAs usually come with a minimum of about 2 MB of memory, and may have as much as 32 MB. Some PDAs are designed to have upgradeable memory.

PDAs are usually powered by batteries, since their primary advantage over other PCs is portability. The battery types vary from model to model, but may include standard AA or AAA batteries, rechargeable batteries or battery packs, or the like. Most PDAs are also equipped with AC adapters for recharging their batteries and allowing operation of the PDA using line current. Battery life depends on the kind of batteries used, the make and model PDA they are used with, and the use the PDA is put to. For example, PDAs using the POCKETPC™ operating system tend to experience more of a power drain since POCKETPC™ is generally more complex and has greater memory requirements than other operating systems. Likewise, running programs with greater memory use drains power faster. Using functions such as color LCD displays, sound recording and/or playback, and the like can also quickly drain battery power. Also, frequency of use is directly proportional to power drainage. Accordingly, battery life may range from a few hours to several weeks depending upon the PDA model and features and the usage type and frequency. Typically, PDAs have internal power management systems in place to extend the battery life and warning functions to alert the user when the batteries are low. During battery replacement, the internal capacitance of the PDA circuitry is sufficient to maintain RAM memory for about a minute, after which RAM memory may be lost.

PDAs are designed to supplement and enhance personal computers, and as such must be able to share data with them. In other words, information changes made to the one device must necessarily be updated in the other. Further, since PDAs have no permanent power source-independent memory storage capacity, all information stored in a PDA should be periodically downloaded and saved to the hard drive of a PC to prevent permanent data loss in the event of a PDA power failure. Therefore, PDAs are equipped to communicate with PCs. The communication process between PDAs and PCs is called data synchronization or syncing and is typically accomplished via a direct physical connection between the PDA and PC, such as through an electrical connection extending from a serial or USB port on the PDA to an input port on the PC. Some PDAs are capable of communicating with PCs through infrared communications ports that use infrared (IR) radiation as a communications medium and may thus communicate with like-equipped PCs or other PDAs. Some PDAs also include wireless communications hardware for the transfer of data between a PC/PC network through a wireless e-mail and/or internet service provider.

One embodiment of the present invention relates to a communications system for connecting a stand-alone computer, such as a personal computer or PC (such as a desk top or laptop computer) to a computer network. The computer network may be any network of two or more interconnected computers, such as a local area network (LAN), a wide area network (WAN) or a global network, such as the Internet. The communications system further includes a personal digital assistant (PDA) having a wireless transceiver and a data input/output port, such as a serial port, for connecting to a personal computer. The PDA is connected through its data port to the personal computer, such as via a cable or wire extending between the PDA data port and a like data port on the PC, such that data may be readily transferred therebetween. In other words, the PDA and PC are connected in electric communication with each other. In some alternate embodiments, data may be communicated between the PDA and PC via infrared signals sent between the two.

The PDA also includes a transceiver that may be instructed to emulate the connectivity functions of a modem. Once the PDA is so programmed, its transceiver may be used to wirelessly send signals to a computer network via pre-existing wireless communications networks, allowing the personal computer to access the computer network through the personal digital assistant. The PDA may have a pre-existing Internet browser function. The PDA more preferably has at least 4 megabytes of available RAM memory.

CDPD protocol as referenced above is illustrative of one embodiment of the present invention and one of ordinary skill in the art would realize that the instant invention is not limited in scope to any specific protocol. In other words, the PDA may be programmed to address any of the packet data wireless modalities (e.g., CDMA, TDMA, GSM, iDEN, GRPS, etc.), currently known or unknown, such as the wireless modalities associated with and/or proposed for 2.5 and 3G technologies, so called ‘Smart Phones’, and the like.

As used herein, PDAs are defined both physically and functionally. In other words, a PDA is defined as a device having dedicated functions actually programmed thereinto and acted upon within the device itself. For example, many ‘cell phones’ have limited PDA functions that occur within the device. Storage of data such as contact lists (i.e., names and phone numbers) are the most common of these PDA-like functions. The PDA-like function is more developed in cases wherein the contact list comprises a more detailed set of information is stored regarding the contacts. Some ‘cell phones’ can retrieve this kind of information but do not store it internally and depend on outside dedicated services from a cellular provider. This is also true for things such as maintaining an appointment calendar, task lists, notes, etc. This distinction becomes more important since future cell phones will no doubt integrate increasingly PDA-like functions thereinto as the technology matures, thus allowing for integration of the instant invention to be easily programmed into them, since they will be fusing the functions of both a PDA and a cellular telephone. The modem-emulation function would also follow this integration through the PDA within a telephone implementation. Current cellular telephones perform modem functions in much the same way as the dial-up modem typically connecting a computer to a telephone line. In contrast, the modem-emulation function of the present invention utilizes the already existing connection of a wireless PDA to its network and is invoked as needed by the computer, similar to the utilization of a DSL line that is continually connected.

In operation, a personal computer may be wirelessly connected to a computer network via an intermediary device such as a PDA having a wireless communications transceiver. The intermediary device is programmed to emulate a modem function via its transceiver. The intermediary device is also electrically connected to the personal computer, such as by a cable extending between the data I/O ports of the intermediary device and the personal computer, allowing data to be easily transferred therebetween. The intermediary device is then wirelessly connected to the computer network. The personal computer is thusly enabled to communicate with the computer network through the intermediary device as though it were a modem.

Network connectivity may be addressed in at least two ways. Programming may be added to the computer being served to allow its network access software (e.g., its web browser) to communicate its request via the PDA. This may take two paths. For those PDAs equipped with a web browser the user may chose to simply have the added programming residing in the PDA direct the inquiry through that web browser. The user may alternatively direct the query to be routed by the added programming residing in the PDA to a specific network server for subsequent processing.

The modem-emulation or modem-like function of the present invention is a communications system consisting of several different components that reside within the PC environment, the PDA, and on the wireless network. Within the PC environment, software or programming is installed as a network interface driver, allowing any IP native or Internet-ready application to access this function without further modifications or configurations. The network interface driver loaded into the PC communicates with the PDA through a standard serial, USB, infrared or other device supported by the PDA. The software installed on the PDA can perform in one of at least two different modes. One mode utilizes existing web or Internet access software development modules already loaded in the PDA to provide information access with a translation, or transport, to the PC. In this mode, no outside equipment is required.

Another mode accesses the PDA's wireless transport driver directly to communicate with an access server connected to the wireless network. In this mode, the access server replaces the PDA's inherent web or Internet access function. The access server accepts communications from the PC via the wireless PDA, performs information manipulation functions, such as information retrieving, gathering, organizing and the like, and returns the results via the wireless network and the PDA back to the PC. Data leaving the PC destined for the access server is compressed and encrypted. This compression process allows for an apparent increase in throughput through the wireless network. All data is encrypted and compressed at the PC and at the access server, removing any processing requirements from the PDA. Doing this allows for higher processing capabilities that are no longer constrained by the limited processing capabilities of the PDA. The PDA may then be used substantially exclusively as a transport device.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A communications system, comprising:
a personal computer;
a computer network;
a personal digital assistant connected in electric communication to the computer and in wireless communication to the computer network;
wherein the personal computer can access the network through the personal digital assistant.

2. The communications system of claim 2 wherein the personal digital assistant further comprises a transceiver for wireless communication and wherein the personal digital assistant is programmed to emulate a modem.

3. The communications system of claim 1 wherein the personal digital assistant further comprises an Internet browser.

4. The communications system of claim 1 further comprising an access server connected in wireless communication with the personal digital assistant and in electric communication with the computer network, wherein the access server is adapted to accept accept communication from the personal computer through the personal digital assistant, wherein the access server is adapted to perform information manipulation functions, and wherein the access server is adapted to communicate information back to the personal computer through the personal digital assistant.

5. The communications system of claim 1 wherein the computer network is the Internet.

6. The communications system of claim 1 wherein the personal computer is modemless.

7. The communications system of claim 1 wherein the personal computer is programmed with a network interface driver to allow any pre-existing network connection functions to communicate with the personal digital assistant.

8. A method for wirelessly connecting a personal computer to a network via an intermediary device having a wireless communications function, comprising the steps of:
(a) programming the intermediary device to emulate a modem;
(b) programming the personal computer to communicate with the intermediary device;
(c) electrically connecting the intermediary device to the computer; and
(d) wirelessly connecting the intermediary device to the network.

9. The method of claim 8 further comprising the step of before step a), downloading modem emulation software into the intermediary device from a designated host.

10. The method of claim 8 further comprising the step of before step a), downloading network interface driver software into the personal computer from a designated host.

11. The method of claim 8 wherein the intermediary device is a personal digital assistant.

12. The method of claim 11 wherein the personal digital assistant further comprises an Internet web browser and a wireless transceiver.

13. The method of claim 8 wherein step c) further comprises connecting the intermediary device to the network through an access server, wherein the access server is adapted to accept communication from the personal computer through the intermediary device, wherein the access server is adapted to perform information manipulation functions, and wherein the access server is adapted to communicate information back to the personal computer through the intermediary device assistant.

14. The method of claim 8 wherein the network is the Internet.

15. The method of claim 8 wherein the personal computer is without a modem.

16. The method of claim 8 wherein the personal computer is without access to telephone lines.

17. A method of using a personal digital assistant having a wireless communications transceiver to connect a personal computer to the Internet, comprising the steps of:
aa) instructing the transceiver to emulate a modem;
bb) establishing a communications link between the personal digital assistant and the personal computer; and
cc) wirelessly connecting the personal computer to the Internet through the personal digital assistant.

18. The method of claim 17 wherein step cc) further comprises connecting the personal digital assistant to the Internet through an access server, wherein the access server is adapted to accept accept communication from the personal computer through the personal digital assistant, wherein the access server is adapted to perform information manipulation functions, and wherein the access server is adapted to communicate information back to the personal computer through the personal digital assistant.

19. The method of claim 17 wherein a wire extends between the personal digital assistant and the personal computer and wherein the personal digital assistant and the personal computer are in electric communication through the wire.

20. The method of claim 17 wherein the communications link between the personal digital assistant and the personal computer comprises infrared radiation.

20. The method of claim 17 wherein the personal computer is without access to telephone lines.
